(19) United States
(12) Patent Application Publication
(10) Pub. No.: US 2003/0222471 A1
(43) Pub. Date: Dec. 4, 2003

(54) Bottom piece on handle of hand tool

(76) Inventor: Chang-Ying Chen, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/155,138

(22) Filed: May 28, 2002

(51) Int. Cl. A45F 5/00; B25G 1/00

(52) U.S. Cl. 294/137

(57) ABSTRACT

A handle assembly for a hand tool includes a tongue extending from a distal end of a handle and a bottom piece is rotatably mounted on the tongue and a collar portion extends radially outward from an outer surface of the bottom piece. A description is marked on an end surface of the bottom piece and a casing is mounted to bottom piece. An aperture is defined through a close end of the casing so as to see the description via the aperture.

### FIELD OF THE INVENTION

The present invention relates to a bottom piece on the handle of a hand tool and the bottom piece includes a body enclosed by a casing with different color from that of the body.

### BACKGROUND OF THE INVENTION

A conventional hand tool such as a screwdriver as shown in FIGS. 1 and 2 generally includes a handle 10 and a shank extends from the first end of the handle 10 and a function end 17 is connected to the shank. A description 18 of the specification of the hand tool is marked on the outer surface of the handle 10. A tongue 13 extends from the second end of the handle 10 and a flange 14 extends radially outward from the tongue 13. A bottom piece 11 has a recess 15 defined in an end thereof and a groove 16 is defined in an inner periphery of the recess 15 so that when the bottom piece 11 is mounted on the tongue 13, the flange 14 is engaged with the groove 16. A collar 12 generally made of metal is mounted on the tongue 13 and located between the end of the bottom piece 11 and the second end of the handle 10. Therefore, the bottom piece 11 can be rotated relative to the tongue 13. An inherent shortcoming of the arrangement of the bottom piece 11 and the handle 10 is that the collar 121 is easily rusted and contaminates the handle 10. In addition, the description 18 is easily to be worn out.

The present invention intends to provide a bottom piece rotatably connected to the handle and the description of the tool can be shown at the end surface of the bottom piece.

SUMMARY OF THE INVENTION

In accordance with one aspect of the present invention, there is provided a handle assembly for a hand tool and the assembly comprises a tongue extending from a distal end of a handle and a bottom piece is rotatably mounted on the tongue. A collar portion extends radially outward from an outer surface of the bottom piece and a description is marked on an end surface of the bottom piece. A casing has a recess defined in a first end thereof and the bottom piece is received in the recess of the casing. An aperture is defined through a second end of the casing so as to see the description.

The primary object of the present invention is to provide a handle assembly of a hand tool wherein the specification of the tool can be shown in the end of the handle assembly.

The other object of the present invention is to provide a handle assembly wherein the casing and the collar portion on the bottom piece have different colors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional handle assembly of a hand tool;

FIG. 2 is a cross sectional view to show the conventional handle assembly of a hand tool;

FIG. 3 is an exploded view to show the handle assembly of a hand tool of the present invention;

FIG. 4 shows a male mold and a female mold for manufacturing a casing to be mounted on the bottom piece;

FIG. 5 is a cross sectional view to show the casing made between the male mold and the female mold, and

FIG. 6 is a perspective view to show the handle assembly of the present invention.

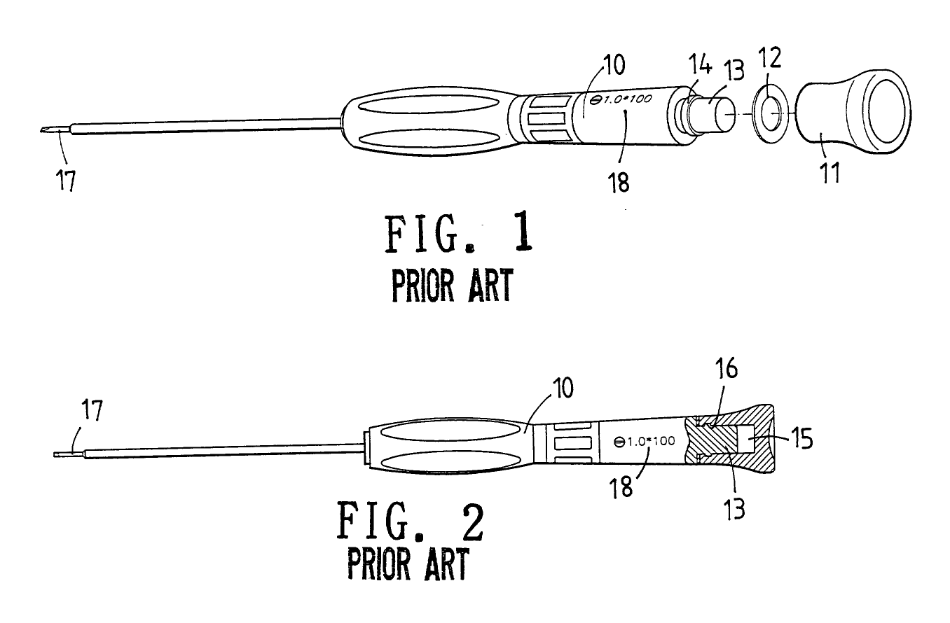

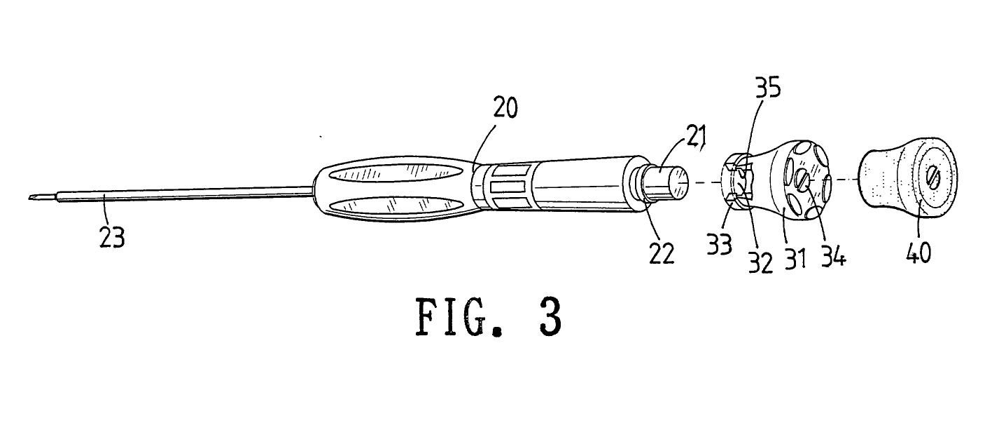

### DETAILED DESCRIPTION OF THE PREFERRED EMBODIMENT

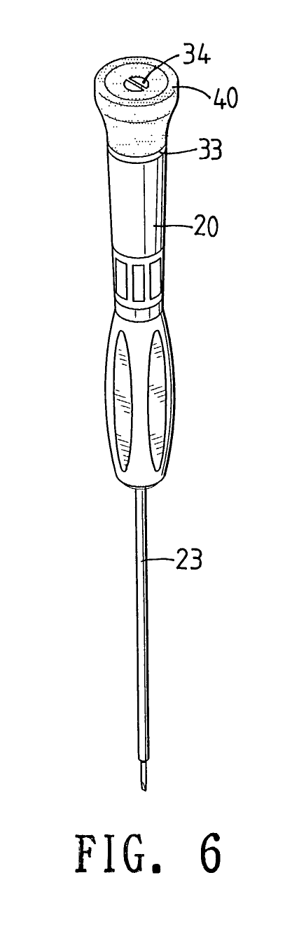

Referring to FIGS. 3 and 6, the handle assembly for a hand tool of the present invention comprises a tongue 21 which extends from a distal end of a handle 20 of the hand tool which includes the handle 20 and a shank extending from the handle 20. A function end such as a cabinet end as shown is connected to a distal end of the shank. The tongue 21 has a flange 22 extending from an outer periphery thereof.

A bottom piece 31 is rotatably mounted on the tongue 21 and a collar portion 33 extends radially outward from an outer surface of the bottom piece 31. A groove 35 is defined in an inner periphery thereof so as to receive the flange 22 in the groove 35. A description 34 for the type and size of the function end is marked on an end surface of the bottom piece 31.

A casing 40 has a recess 32 defined in a first end thereof and the bottom piece 31 is received in the recess 32 of the casing 40. The first end of the casing 40 is flush with the outer surface of the collar portion 33. An aperture is defined through a second end of the casing 40 and the description 34 is located in alignment with the aperture in the casing 40 so that the description 34 can be seen via the aperture. The description may also be made to be convex from the end surface of the bottom piece 31 and is engaged with the aperture in the casing 40. The outer surface of the collar portion 33, the handle 20 and the casing 40 have different colors and the color of the collar portion 33 has a preset meaning to let the user to pick the right tool quickly.

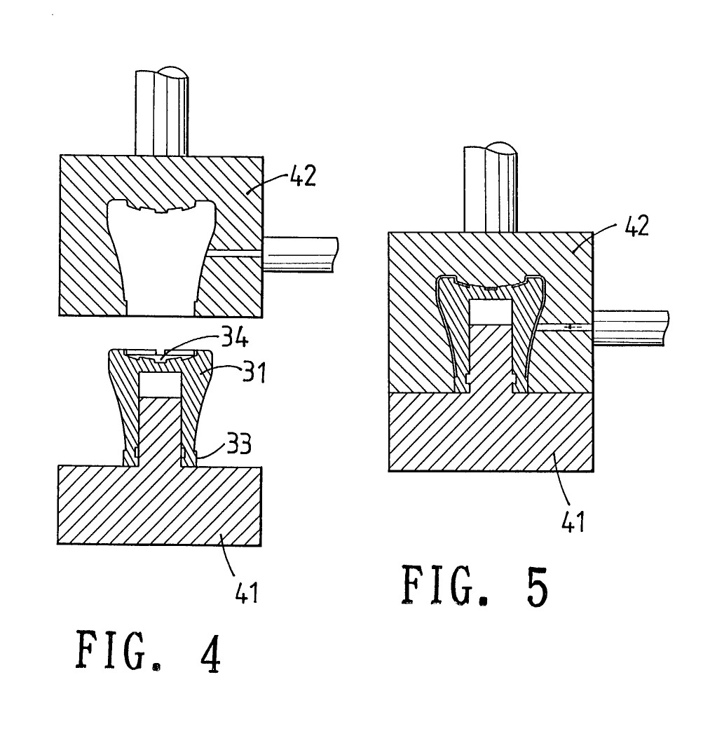

Referring to FIGS. 4 and 5, the casing 40 can be manufactured by mounting the bottom piece 31 on a protrusion of a male mold 41, and a female mold 42 having a concavity is mounted onto the bottom piece 31. A gap is defined between the inner periphery of the concavity of the female mold 42 and the outer surface of the bottom piece 31. Proper material is injected in the gap via a passage in the female mold to form the casing 40 which is securely mounted onto the bottom piece 31. The first end of the casing 40 is ended before the collar portion 33 of the bottom piece 31 so that the collar portion 33 can be seen.

While we have shown and described the embodiment in accordance with the present invention, it should be clear to those skilled in the art that further embodiments may be made without departing from the scope of the present invention.

What is claimed is:

1. A handle assembly for a hand tool, comprising:
a tongue extending from a distal end of a handle of the hand tool;
a bottom piece rotatably mounted on the tongue and a collar portion extending radially outward from an outer surface of the bottom piece, a description marked on an end surface of the bottom piece, and
a casing having a recess defined in a first end thereof and the bottom piece being received in the recess of the casing, an aperture defined through a second end of the casing, the description located in alignment with the aperture in the casing.

2. The handle assembly as claimed in claim 1, wherein the tongue has a flange extending from an outer periphery thereof and the bottom piece has a groove defined in an inner periphery thereof, the flange being engaged with the groove.

3. The handle assembly as claimed in claim 1, wherein the first end of the casing is flush with the outer surface of the collar portion.
